(19) United States
(12) Patent Application Publication
(10) Pub. No.: US 2008/0183542 A1
(43) Pub. Date: Jul. 31, 2008

(54) Method for Resource Planning of Service Offerings

(76) Inventors: Daniel Patrick Connors, Pleasant Valley, NY (US); John Peter Fasano, Briarcliff Manor, NY (US); Donna Leigh Gresh, Cortlandt Manor, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 12/057,854

(22) Filed: Mar. 28, 2008

Related U.S. Application Data
(63) Continuation of application No. 11/171,389, filed on Jul. 1, 2005.

(51) Int. Cl. G06Q 10/00

(52) U.S. Cl. 705/8

(57) ABSTRACT

The invention provides a method for optimizing a sourcing strategy for potential services offerings of large, multinational services organizations. This optimization method considers existing capabilities, resource skills, locations of the resources, costs of the resources, desired profit margins and other strategic sourcing policies to produce an optimized service offering staffing plan.

### BACKGROUND OF THE INVENTION

1. Field of the Invention

The present invention generally relates to the field of automated resource planning for one or more large, global services organizations and, more particularly, to the methods and tools for constructing feasible and optimal sourcing strategies for new and existing service offerings.

2. Background Description

Currently, professional services providers design service offerings and make decisions of how to source the offerings independent of resource costs and constraints. Traditionally, resources are allocated manually by those involved in the project management negotiating for available resources within the local delivery area. There is very little planning that includes resources across the entire organization. Professional services organizations are aware of the types of skills and capabilities of the general population within the organization. However, the service offering does not usually consider availability, costs, location, and other constraints of the members of the population whose skills and capabilities are needed to support a particular service offering, especially outside the immediate area of either the delivery group or the customer location. This may result in inefficiencies with how staff is assigned to particular service deliveries, and staffing plans that are either infeasible or do not achieve the desired profit margin targets.

One of the primary reasons for these inefficiencies or inadequacy of the resource planning efforts is the scope or magnitude of the services offerings and delivery requirements. That is, services delivery providers have become large, global organizations with tens of thousands or more resources located around the globe and service delivery project revenues in billions of dollars. Resource planning for these types of global services organizations requires an automated computer-implemented method that can analyze the enormous amount of data required to optimize the resource allocation across the entire delivery arena.

Professional service organizations would benefit from service offering design tools that identify which resources should be used, acquired or developed to support new or existing offerings. When speaking of services offerings, the types of capabilities and staffing requirements typically considered include those capabilities of the individuals who will be delivering the required service. The resources required for the services offerings may include but not be limited to C++ programmers and other types of software programmers, project managers, quality assurance and test engineers, clerical staff, hardware maintenance engineers, and installation technicians, etc.

The allocation of resources to new and existing service offerings requires a full knowledge of the skills, costs and availability of the resources within the organization. This does not seem to be a difficult problem when staffing a single project from the entire pool of a company's resources. However, as discussed above, the problem becomes significant when the number of projects becomes large and the constraints on the company resources expand. Furthermore, as human resources cannot be split by skill set, managing the optimum skills sets for a project while considering cost, availability, location and other constraints further complicates the sourcing problem.

### SUMMARY OF THE INVENTION

An exemplary embodiment of the invention provides a method for optimizing the sourcing strategy for new and existing service offerings that considers existing resource skills, locations of the resources, costs of the resources, desired profit margins and strategic sourcing policies.

Another exemplary embodiment of the invention models the demand uncertainty for the various new and existing services offerings, and develops a staffing plan that is robust against the uncertainty of the market demands for the new and existing offerings.

Yet another exemplary embodiment of the invention provides a capability that allows for contingencies of allocating resources when initial planning efforts have sudden changes.

According to the invention, a computer-implemented method is designed to consider the broad spectrum of resource capabilities together with resource constraints in order to present staffing plans for multiple service offerings. These staffing or resourcing plans are designed to provide the optimal resource allocation with contingency considerations. The term optimal is intended to maximize the service provider's strategic goals such as margin targets, delivery quality, customer retention, balanced allocation by location, and other strategic goals, as appropriate. Those skilled in the art will recognize that the method could include additional strategic goals and constraints to those mentioned here.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of some of the inputs and outputs for the services offerings resource optimization method.

FIG. 2 provides a flowchart of the steps for implementing the optimization method.

### DETAILED DESCRIPTION OF A PREFERRED EMBODIMENT OF THE INVENTION

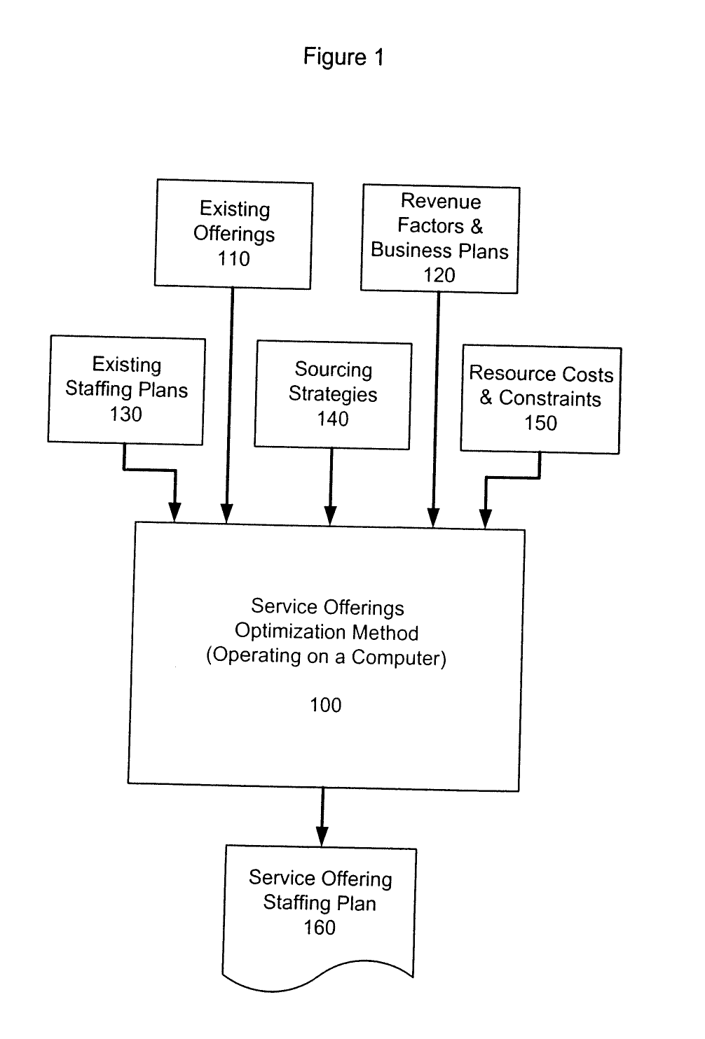

Referring now to the drawings, and more particularly to FIG. 1, there is shown a block diagram of some of the inputs and outputs for the services offerings resource optimization method. As professional services organizations create new offerings and refine existing offerings, the organizations must decide on how staffing these offerings will be sourced. The key elements of the services offerings resource optimization method are the collection of input data, formulating the optimization problem, solving the optimization problem, and executing the resulting strategy. The full set of existing services offerings 110 needs to be assessed for its capabilities. Once the capabilities of the existing offerings 110 are understood, the new offerings can be developed as a set of capabilities that complement and/or contrast with those of the existing offerings 110. Since new and existing offerings will be looking to the same pool of resources to meet staffing needs, the staffing plan of all services offerings, both existing and new must be optimized. The type of data to be collected to define the resources depends on the sourcing flexibilities specified by the sourcing strategies 140 of the organization. For example, if off-shore resources are not permitted, then data about off-shore resources does not need to be collected. In order to explore sourcing alternatives, existing staffing plans 130 must be evaluated to define current staffing needs and capabilities against future staffing requirements. Frequently, services organizations have structural, cost and other self-imposed business constraints. These resource costs and constraints 150 must also be collected and analyzed. For example, the services organization may want to guarantee a minimum amount of work for each of its locations while not sending a disproportionate amount of work to one location. In addition, the services organization may be seeking to maximize profits, achieve serviceability targets, obtain market share, reduce risks, or meet some other objectives defined by the revenue factors and business plans 120 of the organization.

In this embodiment, the type of information within the revenue factors and business plans 120 that may be considered individually or as a composite may include: revenue growth, cost reduction, linkage to business imperatives, productivity enhancement, competitive advantage, and speed of benefit delivery. In another embodiment, a subset of these factors could be used or additional factors could be considered. While business risk is a measure of business impact as a probability of occurrence over a lifetime and, in this embodiment, may be defined as a composite of: schedule risks, life cycle cost, initial costs, feasibility risks, reliability risks, technical risks, management risks, security, and technical obsolescence. In another embodiment, a subset of these factors and risks could be used or additional factors and risks could be considered.

Once the data has been collected and evaluated, the services offerings resource optimization method 100 formulates the sourcing strategy design as an optimization problem. Depending upon the specific input data, constraints and objectives, this optimization problem may be a linear program, a mixed integer program, or it may take the form of other types of optimization problems. Once the optimization problem is solved, the services offerings resource optimization method 100 produces the services offering staffing plan 160.

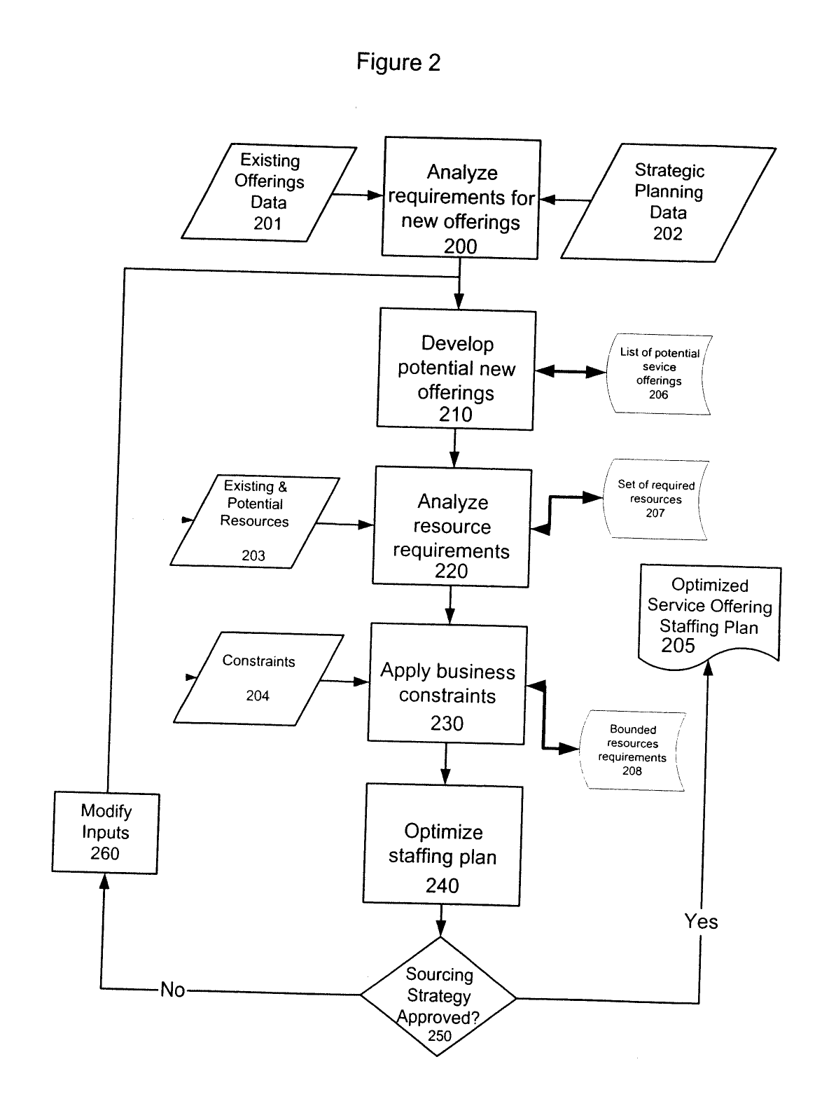

FIG. 2 shows the process flow for determining the sourcing strategy and creating the staffing plan for new and existing services offerings. The first step of the method is to analyze the requirements for potential service offerings (step 200). Potential service offerings may include new services offerings and/or modifications of existing service offerings. This analysis requires access to existing offerings data 201 and strategic planning data 202. These data could be stored in a database or multiple databases within the service organizations network. These data could be transmitted to the system that implements the method either directly or through a network. The data would include the description in terms of skills and attributes of the resources needed to deliver the existing services. For the purposes of this invention, attributes of the resources could include but not be limited to skill level, location, cost, or availability. Once the existing services data 201 has been analyzed, the strategic planning data 202 is also analyzed. This data identifies those capabilities that are available or planned that are not currently offered through an existing service offering. From this analysis potential new service offerings are developed at step 210. As part of the development of new service offerings (step 210), the capabilities and resource requirements for the existing service offerings may be modified.

A set of potential service offerings 206, which includes modified existing and new service offering, is compiled as the output from step 210. Using this list of potential service offerings together with the existing and potential resources 203 data, the resource requirements for each of the individual offerings is analyzed at step 220. The potential resources are those resources that could be made available through hiring, training, sub-contracting or other commonly implemented actions. That is, the ideal set of resources in terms of skills and attributes is identified for each of the potential service offerings. The result of this step would be a set of resources 207 required to implement all of the potential service offerings identified in step 210.

The method then applies the real world and business defined constraints 204 to bound the potential service offering and the resource requirements at step 230. Some of these constraints may include revenue margins, availability of specific skills sets, location of resources, cost of resources, security issues, citizenship regulations, time zone impacts, etc. Those skilled in the art will recognize that these are only a sample of the types of business and real world constraints that could be applied and the invention is not limited to those mentioned here. The process then applies the constraints 204 which results in a set of bounded resources 208. The inputs and results of each of the method steps, specifically 201, 202, 203, 204, 206, 207, and 208 may be stored in a database or several data bases within the service organization network to be used by the various iterations of the computer implemented optimization process and/or for use by other processes within the service organization.

Using the list of potential service offerings together with the set of required resources that are bounded by the constraints, the method formulates an optimization problem and solves that problem at step 240 using a solver that is appropriate for the type of problem formulated. The solution to the problem is the sourcing strategy. A variety of different mechanisms for formulating an optimization problem and solving the problem can be used including, without limitation optimization solvers such as maximum/minimum, constraint bound, branch and bound, evolutionary algorithm, stochastic processing and other optimization solver techniques.

The optimization method selected can optimize the staffing plan based on cost or priority. In the case of a cost based optimization method, the staffing plan which is developed as the output would recommend staffing to maximize income by minimizing cost and/or maximizing margins. The priority based optimization method would output a staffing plan that meets specific priorities (e.g., staff engagement first from US resources, do not hire any new programmers, etc.) which are entered as part of the strategic planning data 202 inputs. Although the invention has described cost based optimization or priority based optimization those skilled in the art will recognize that the invention can be practiced with modification within the spirit and scope to include other types of optimization to include but not be limited to a combination of cost and priority based optimization method.

Once the sourcing strategy has been developed, the services organization must approve the strategy at step 250. This step can be a manual decision process performed by appropriate individuals or groups of individuals within the service organization. Alternatively, the sourcing strategy could be automatically evaluated against a predetermined set of criteria. This decision step also provides additional design flexibility to consider demand uncertainty for the various new and existing services offerings.

If the developed sourcing strategy is not approved at step 250, the inputs can be modified at step 260. This input modification step 260 allows for contingencies when allocating resources in the event that initial planning efforts have sudden changes. Modification could include a reduction in the quantity of service project delivery projections or eliminating one or more of the proposed service offerings resulting in a reduction in the needed number of resources with particular skills and/or capabilities. In addition, changes in margins, costs of resources, etc. could also be implemented as part of the input modifications at step 260. These modifications would then be used to revise the input data such as the existing and potential resources 203 and the constraints 204.

The method would then perform the data analysis and optimization process again using the modified data. Once again, the strategy would be presented for approval at step 250. In the event that the sourcing strategy was approved, an optimized services offering staffing plan 205 would be produced. The optimized services offering staffing plan 205 could be stored within corporate or departmental databases or provided as a report to be distributed throughout the services organization. The optimized services offering staffing plan 205 could also be used as the new existing input data to the method when strategic goals have changed warranting another optimized resource plan.

The methodology described herein can be implemented on computerized systems, and software can store processing steps of the methodology on a computer readable medium (e.g., hard disk, floppy disc, CD, DVD, flash memory, tape drive, etc.).

### EXAMPLE

The following example illustrates the types of data inputs and constraints that are analyzed in developing a resourcing strategy for a single new services offering. When this example is considered with the thousands of services offerings being designed, developed and implemented at one time in many global services organizations, the magnitude of the task and the advantage of the automated optimization method is apparent.

The proposed new services offering for a services organization with 5000 employees located worldwide is defined as:
Install and deploy Vendor XXX's Customer Relationship Management (CRM) System.

The forecasted delivery of the proposed new services offering is to sell 12 of these engagements in the next fiscal year on an average of one per month. Half of the engagements will be delivered in the US and half will be delivered in Europe. This data would be entered as part of the strategic planning data 202. An example is shown in Table 1.

Example Engagement New Offering Data

| Engagement | | | | |
|---|---|---|---|---|
| Name | Revenue | Start Period | Priority | Quantity |
| E1US | $200,000.00 | 0 | 1 | 1 |
| E2US | $200,000.00 | 2 | 1 | 1 |
| E3US | $200,000.00 | 4 | 1 | 1 |
| E4US | $200,000.00 | 6 | 1 | 1 |
| E5US | $200,000.00 | 8 | 1 | 1 |
| E6US | $200,000.00 | 10 | 1 | 1 |
| E1EMEA | $200,000.00 | 1 | 1 | 1 |
| E2EMEA | $200,000.00 | 3 | 1 | 1 |
| E3EMEA | $200,000.00 | 5 | 1 | 1 |
| E4EMEA | $200,000.00 | 7 | 1 | 1 |
| E5EMEA | $200,000.00 | 9 | 1 | 1 |
| E6EMEA | $200,000.00 | 11 | 1 | 1 |

In Table 1, the Start Period is shown as which month in a 12 month cycle the engagement would anticipate starting. The priority is shown as 1 for all engagement although could be set at different priorities if a priority based optimization was desired. Finally, the quantity is set at 1 for each engagement but could change based on sales forecasts.

The existing offerings data 201 would include a listing of all the types of resources required (similar to a build of materials list in a manufacturing environment) to deliver the engagement. Table 2 provides an example of the types of resources that would be required to deliver the first engagement (engagement name E1US) of this example.

TABLE 2
Example Engagement Delivery Resource Requirements

| | | | | | | Resource |
|---|---|---|---|---|---|---|
| Engagement | | Resource | | Usage | Job Role | Location |
| Name | Job Role | Location | Period | Quantity | Substitute | Substitute |
| E1US | Sr. PrjMgr | US | 0 | 1 | 1 | 1 |
| E1US | Sr. PrjMgr | US | 1 | 1 | 1 | 1 |
| E1US | Sr. PrjMgr | US | 2 | 1 | 1 | 1 |
| E1US | Sr. PrjMgr | US | 3 | 1 | 1 | 1 |
| E1US | Sr. PrjMgr | US | 4 | 1 | 1 | 1 |
| E1US | Sr. PrjMgr | US | 5 | 1 | 1 | 1 |
| E1US | Sr. PrjMgr | US | 6 | 1 | 1 | 1 |
| E1US | Sr. PrjMgr | US | 7 | 1 | 1 | 1 |
| E1US | Sr. PrjMgr | US | 8 | 1 | 1 | 1 |
| E1US | JrC++Pgr | US | 2 | 25 | 1 | 1 |
| E1US | JrC++Pgr | US | 3 | 25 | 1 | 1 |
| E1US | JrC++Pgr | US | 4 | 25 | 1 | 1 |
| E1US | JrC++Pgr | US | 5 | 25 | 1 | 1 |
| E1US | JrC++Pgr | US | 6 | 25 | 1 | 1 |
| E1US | JrC++Pgr | US | 7 | 25 | 1 | 1 |
| E1US | EIQATest | US | 7 | 4 | 1 | 1 |
| E1US | EIQATest | US | 8 | 4 | 1 | 1 |
| E1US | SrSysArc | US | 0 | 1 | 1 | 1 |
| E1US | SrSysArc | US | 1 | 1 | 1 | 1 |

Analyzing the requirements for the new service offering would develop a set of required resources for the new offering. The required resources for this example only consider the technical capabilities and are not addressing the clerical or other support staff necessary to maintain the project.

In Table 2 of this example, the first engagement is to be delivered in the US. This engagement requires 4 job roles (i.e., Sr. Project Manager, Jr. C++ Programmer, Test Engineer, and Sr. System Architect) in order to deliver the project to a client. The table shows the period these job roles are required (e.g., EIQA Test Engineers are required during periods 7 and 8). The quantity of each job role required during each time period would also be specified (e.g., 25 Jr. C++ Programmers are required each month during periods 2 through 7). Finally, the optimization system would consider whether these job roles could be substituted and the location of these roles could be substituted. In the example Table 2, this is indicated by a 1 in the Job Role Substitute column and the Resource Location Substitute column. If substitution was not allowed for these features, a “0” may be entered in the respective columns.

Once the ideal set of required resources is defined, the method would analyze these requirements against the availability of existing or potential resources. In this example, the existing resources are shown in Table 3.

TABLE 3
Example Engagement Available Resources

| | Resource | | | |
|---|---|---|---|---|
| Job Role | Location | Period | Supply Quantity | Fixed Cost |
| SrPrjMgr | US | 0 | 2 | $10,000.00 |
| SrPrjMgr | US | 1 | 2 | $10,000.00 |
| SrPrjMgr | US | 2 | 2 | $10,000.00 |
| SrPrjMgr | US | 3 | 2 | $10,000.00 |
| SrPrjMgr | DE | 0 | 1 | $11,000.00 |
| SrPrjMgr | DE | 1 | 1 | $11,000.00 |
| SrPrjMgr | CN | 0 | 4 | $9,000.00 |
| SrPrjMgr | CN | 1 | 4 | $9,000.00 |
| JrC++Pgr | US | 0 | 25 | $5,000.00 |
| JrC++Pgr | CN | 0 | 5 | $4,000.00 |
| JrC++Pgr | IN | 0 | | $1,000.00 |

The example available resources shown in Table 3 are those resources currently available for delivery of the potential service offerings. In this example, the availability of Sr. Project Managers is shown for the US as 2 available each period from period 0 through 3 at a monthly fixed cost of $10,000.00 each Sr. Project Manager. There are 4 available Sr. Project Managers in Canada for the same period of time at a monthly fixed cost of $9,000.00 each. There is also available 1 Sr. Project Manager in Germany for the same time period at a fixed monthly cost of $11,000.00. In addition to existing resources, there is the potential for hiring or retraining resources. An example of these capabilities is shown in Table 4.

TABLE 4
Example Engagement Resource Acquire and/or Release Costs

| | | Acquire | | Release | |
|---|---|---|---|---|---|
| Job Role | Location | Time | Acquire Cost | Time | Release Cost |
| SrPrjMgr | US | 1 | $15,000.00 | 2 | $30,000.00 |
| SrPrjMgr | CN | 1 | $14,000.00 | 2 | $26,000.00 |
| SrPrjMgr | DE | 1 | $16,000.00 | 2 | $64,000.00 |
| JrC++Pgr | US | 0 | $5,000.00 | 2 | $10,000.00 |
| JrC++Pgr | CN | 0 | $4,000.00 | 2 | $8,000.00 |
| JrC++Pgr | DE | 0 | $6,000.00 | 2 | $24,000.00 |
| JrC++Pgr | IN | 0 | $500.00 | 2 | $1,000.00 |
| SrSysArc | US | 1 | $7,000.00 | 2 | $14,000.00 |
| SrSysArc | DE | 1 | $7,500.00 | 2 | $30,00.00 |
| EIQATest | US | 1 | $6,000.00 | 2 | $12,000.00 |
| EIQATest | DE | 1 | $7,000.00 | 2 | $28,000.00 |
| EIQATest | CN | 1 | $5,000.00 | 2 | $10,000.00 |
| FortranPgr | US | 0 | $5,000,000.00 | 2 | $6,000.00 |

Example Table 4 shows the costs and time periods required for acquiring or releasing resources. To acquire new resources would be the cost of hiring the particular Job Role in the respective countries. For Example, to hire a new Sr. System Architect in the US would require $7,000.00 in acquisition costs (e.g., travel, food and expenses for interview, recruiter fees, etc.) and would take 1 time period (e.g., month). The concept of release time and cost is another input because the model allows the staffing plan to be optimized such that unnecessary resources can be released (fired) to eliminate the fixed salary costs. However, because of severance packages and other charges, there may be a cost associated with releasing an unneeded resource. The cost of acquiring more Fortran programmers is shown as $5,000,000.00 which is artificially high. This number was entered to ensure that the optimization scheme would not recommend hiring Fortran programmers. The method would allow other constraint fields to be entered; however, the cost prohibition was used in the example to simplify the number of inputs. However, those knowledgeable in the art would recognize that a large number of additional constraints beyond the cost, quantity could be entered to bound the optimization process.

Finally, the business, technical and real world constraints must be applied to the resource allocations. An example of the constraints for this new services offering could include:
Sr. Project manager and Sr. System Architect must perform work on-site.
Jr. Programming work can be performed off-site, but all programmers must be at the same site.
Entry level quality assurance testing can be performed off-site.
Strategic goal of company is to expand its presence in country ZZZ and would like to place work there if possible.

Obvious real world constraints such as 1 person cannot be located at 2 sites at the same time and expenses for locating resources at various sites have not been included here but these types of real world constraints would be included in the database for the computer-implemented method to consider as part of the analysis.

In addition, the method allows for substitutions to be performed in the event a particular type of Job Role is unavailable at a particular location. For example, the method could enable a US resource be substituted by a Canadian resource. However, due to travel and communication charges, there may be a cost per individual of each substitution. In addition to allowing location substitutions, Job Role substitutions may be allow such as retraining a Fortran Programmer to be a Jr. C++ Programmer. There may be training costs associated with this substitution but these substitution costs may be less than hiring a new Jr. C++ Programmer. The optimization could be run with the substitution enabled or disabled at each element.

Once the inputs and constraints have been collected and analyzed the method formulates the optimization problem. In this example, the goal is to maximize revenue (a cost optimization) while meeting delivery quality goals within the specified resources and constraints. The problem must balance the cost of implementation against the gross revenue to determine optimal delivery scenarios. Once the problem has been formulated using the business strategic and tactical goals, the problem is solved using any one of several optimization solvers such as maximum/minimum, constraint bound, branch and bound, evolutionary algorithm, stochastic processing and other optimization solver techniques. The optimization solver techniques listed here are only for illustration purposes. It would be understood by those skilled in the art that many different optimization solving techniques could be used and this invention is not limited to those listed here.

It should be understood that all staffing plan decisions are made relative to the staffing at period 0. This is the initial or boundary point against which the hire, fire, train, assign, etc. decisions are made. The example was run for four different scenarios: (1) no substitutions enabled, (2) substitution of C++ programmers with Fortran programmers is enabled, (3) substitution of US resource with Canadian resource is enabled, and (4) substitution of India C++ programmers for US and Canadian C++ programmers is enabled. These iterations reflect the sourcing strategy approval (step 250 of FIG. 2) and the modification of inputs (step 260 of FIG. 2).

Table 5 shows the results of the optimization method for the four different scenarios. An approximate net profit after performing the 12 engagements is used as the cost goal for the cost optimization method. As mentioned previously, several other factors such as priority could be used as the basis of the optimization; cost optimization was used in the example presented here.

Table 5 shows the staffing planning for the quantity of Jr. C++ Programmers located in the US. Referring back to the inputs summarized in Table 3, at period 0, there were 25 available Jr. C++ Programmers in the US.

TABLE 5
Example Engagement Staffing Plan for Four Scenarios

| | | No | | ForPgr for | | Canada | | India C++ for | |
|---|---|---|---|---|---|---|---|---|---|
| Job Role - | | Substitutions | | C++Pgr | | for US | | US/DE Pgr | |
| Location | Period | Work | Acq | Work | Acq | Work | Acq | Work | Acq |
| Jr.C++Pgr - US | 0 | 0 | 0 | 0 | 0 | 0 | 0 | 0 | 0 |
| Jr.C++Pgr - US | 1 | 0 | 0 | 0 | 0 | 0 | 0 | 0 | 0 |
| Jr.C++Pgr - US | 2 | 25 | 0 | 25 | 0 | 5 | −20 | 0 | −25 |
| Jr.C++Pgr - US | 3 | 25 | 0 | 25 | 0 | 5 | 0 | 0 | 0 |
| Jr.C++Pgr - US | 4 | 50 | 25 | 35 | 10 | 5 | 0 | 0 | 0 |
| Jr.C++Pgr - US | 5 | 50 | 0 | 35 | 0 | 5 | 0 | 0 | 0 |
| Jr.C++Pgr - US | 6 | 50 | 0 | 60 | 25 | 5 | 0 | 0 | 0 |
| Jr.C++Pgr - US | 7 | 75 | 25 | 60 | 0 | 5 | 0 | 0 | 0 |
| Jr.C++Pgr - US | 8 | 75 | 0 | 60 | 0 | 5 | 0 | 0 | 0 |
| Jr.C++Pgr - US | 9 | 75 | 0 | 60 | 0 | 5 | 0 | 0 | 0 |
| Jr.C++Pgr - US | 10 | 75 | 0 | 60 | 0 | 5 | 0 | 0 | 0 |
| Jr.C++Pgr - US | 11 | 75 | 0 | 60 | 0 | 5 | 0 | 0 | 0 |
| Jr.C++Pgr - US | 12 | 75 | 0 | 60 | 0 | 5 | 0 | 0 | 0 |

| | | | | |
|---|---|---|---|---|
| Profit | $350,000.00 | $2,500,000.00 | $8,500,000.00 | $17,000,000.00 |

As shown in the first scenario, if only US Jr. C++ Programmers were to be used, the company would need to hire 25 additional Jr. C++ Programmers in period 4 and then another 25 in period 7. The costs associated with this action would result in a profit margin after completion of all 12 engagements of $350,000.00. This would obviously not be approved at the strategic planning approval step. If the inputs were modified to allow substitution of the less expensive Fortran Programmers for the more expensive US based Jr. C++ Programmers, considering retraining costs, the profit for this second scenario would be $2.5M. Continue across Table 5, the third scenario would allow Canadian resources to be substituted for US resources. Using the Canadian resources and the hiring costs for acquiring more Canadian programmers, the company could release 20 US based Jr. C++ Programmers in period 2. The end of engagement profit would then be $8.5M. Finally, allowing Indian programmers to be substituted for US and German programmers allows all 25 US Jr. C++ Programmers to be released in period 2 and the resulting profit would be $17M. Table 5 does not show the acquired resources in the other countries but these numbers would be calculated as part of the optimization process.

In summary, once the optimization problem was solved, a sourcing strategy would be presented. This strategy would define which resources would be assigned to which implementations of the project. The hiring, firing, and training as well as the location of resources would be defined with the related costs for this strategy. The strategy would then be subjected to approval against a set of predetermined criteria. These criteria might include weighting factors against target revenue margins. That is, the delivery of one particular project may be optimized for revenue but when the total number of delivery requirements is considered, the margin for an individual project may be reduced while the average margin across all the forecasted projects maybe improved. If the strategy is not approved, the method would allow modification of inputs for example, the target revenue margin may be changed for the new offering or the length of time required to complete an implementation maybe changed. Once these modifications have been entered, the method would re-evaluate the new offering against the input parameters. A revised strategy would be produced and refined as necessary. Once the strategy was approved, the method would create the optimized service offering staffing plan as the output. This plan would then be implemented for the new offerings.

While the invention has been described in terms of its preferred embodiments, those skilled in the art will recognize that the invention can be practiced with modification within the spirit and scope of the appended claims.

What is claim as new and desire to secure by Letters Patent is as follows:

1. A computer-implemented method for optimizing service offering staffing plans for an organization, comprising:
analyzing capabilities and objectives of said organization;
developing at least one of a set of potential service offerings;
evaluating, using a computer, resource requirements for at least one of said set of potential services offerings;
applying, using said computer, constraints to bound at least one of said set of potential service offerings;
optimizing a staffing plan to be outputted as a sourcing strategy, and if said sourcing strategy is not approved, modifying inputs to said computer and performing the step of optimizing again; and
producing, using said computer, an optimized service offering staffing plan, if said sourcing strategy is approved.

2. The method of claim 1 wherein said analyzing capabilities and objectives step comprises analyzing objectives which include at least one of skills and attributes required for providing at least one of a group of existing service offerings, and wherein objectives include at least one of a group of strategic goals of said organization.

3. The method of claim 1 wherein said developing at least one of said set of potential service offerings step includes new service offerings and/or modified existing service offerings.

4. The method of claim 1 wherein said evaluating resource requirements step includes evaluating existing resources and potential resources.

5. The method of claim 1 wherein said applying constraints applies at least one of predetermined real world, business and technical constraints.

6. The method of claim 1 wherein said optimizing a staffing plan step includes the steps of designing an optimization problem and solving said optimization problem.

7. A computerized system for optimizing service offering staffing plans for an organization, comprising:
at least one computer or network of computers into which is input capabilities and objectives of said organization and at least one of a set of potential service offerings, said computer or network of computers evaluates resource requirements for at least one of said set of potential services offerings and applies constraints to bound at least one of said set of potential service offerings, said computer optimizes a staffing plan to be outputted as a sourcing strategy and, if said sourcing strategy is not approved, modifies inputs to said at least one computer or network of computers and repeats optimization, and produces an optimized service offering staffing plan, if said sourcing strategy is approved; and
one of a display, a printer, or a storage medium for receiving or reproducing said optimized service offering staffing plan.

8. The computerized system of claim 7 wherein said capabilities comprises skills and attributes required for providing at least one of a group of existing service offerings, and objectives includes at least one of a group of strategic goals of said organization.

9. The computerized system of claim 7 wherein said at least one of said set of potential service offerings includes new service offerings and/or modified existing service offerings.

10. The computerized system of claim 7 wherein said resource requirements includes existing resources and potential resources.

11. The computerized system of claim 7 wherein said constraints includes at least one of predetermined real world, business and technical constraints.

12. A computer readable medium encoding a program which executes the following steps:
analyzing capabilities and objectives of said organization;
developing at least one of a set of potential service offerings;
evaluating, using a computer, resource requirements for at least one of said set of potential services offerings;
applying, using said computer, constraints to bound at least one of said set of potential service offerings;
optimizing a staffing plan to be outputted as a sourcing strategy, and if said sourcing strategy is not approved, modifying inputs to said computer and performing the step of optimizing again; and
producing, using said computer, an optimized service offering staffing plan, if said sourcing strategy is approved.

13. The computer readable medium of claim 12 wherein a portion of said program used for analyzing capabilities and objectives comprises instructions or data for analyzing objectives including skills and attributes required for providing at least one of a group of existing service offerings, and instructions or data for objectives including at least one of a group of strategic goals of said organization.

14. The computer readable medium of claim 12 wherein a portion of said program used for developing at least one of said set of potential service offerings comprises instructions or data wherein at least one of said set of potential service offerings includes new service offerings and/or modified existing service offerings.

15. The computer readable medium of claim 12 wherein a portion of said program used for evaluating resource requirements includes instructions or data for existing resources and potential resources.

16. The computer readable medium of claim 12 wherein a portion of said program used for applying constraints includes instructions or data for at least one of predetermined real world, business and technical constraints.

17. The computer readable medium of claim 1 wherein a portion of said program used for optimizing a staffing plan includes instructions or data for designing an optimization problem and solving said optimization problem.
